(19) United States
(12) Patent Application Publication
(10) Pub. No.: US 2008/0025470 A1
(43) Pub. Date: Jan. 31, 2008

(54) Radiation shielded door

(76) Inventor: Andreas Streyl, Alzey (DE)

Correspondence Address: MG-IP Law, PLLC, P.O. BOX 1364, FAIRFAX, VA, 22038-1364, US

(21) Appl. No.: 11/878,786

(22) Filed: Jul. 26, 2007

Related U.S. Application Data
(63) Continuation of application No. PCT/EP06/00397, filed on Jan. 18, 2006.

(30) Foreign Application Priority Data
Jan. 26, 2005 (DE) DE 102005016632

(51) Int. Cl. H05G 1/02

(52) U.S. Cl. 378/203

(57) ABSTRACT

A radiation-shielded door is provided, especially for use in an X-ray testing device. Radiation shielded closures in the form of lead curtains are disadvantageous in that they graze the object to be tested, thereby impairing the same and no longer covering the entire opening of the radiation tunnel. These disadvantages are avoided by using a radiation-shielded door which is configured by at least two movably arranged, radiation-absorbing lamellae forming the door, the faces of which are levers interlinked to give a lazy tongs-type mechanism.

This nonprovisional application is a continuation of International Application No. PCT/EP2006/000397, which was filed on Jan. 18, 2006, and which claims priority to German Patent Application No. DE 102005016632, which was filed in Germany on Jan. 26, 2005, and which are both herein incorporated by reference.

### BACKGROUND OF THE INVENTION

1. Field of the Invention

The present invention relates to a radiation shielded door, in particular for an X-ray inspection system.

2. Description of the Background Art

X-ray inspection systems are frequently used in the non-invasive inspection of objects such as luggage or packages. In this process, the objects to be inspected are typically conveyed through a radiation tunnel by a conveyor. It is important that no radiation, or only very little, exits the radiation tunnel during this process. It is known from, for example, DE 101 31 407 A1, which corresponds to U.S. Pat. No. 6,663,280, to close the entry and exit of the tunnel with radiation shielding curtains made of lead.

A disadvantage in the prior art is that a curtain brushes past the object to be inspected and can cause it to become caught or tipped over. Another disadvantage is that the curtain is pushed aside by the object and thus no longer covers the entire opening of the tunnel.

### SUMMARY OF THE INVENTION

It is therefore an object of the present invention to provide an improved radiation shielding closure.

This object is attained according to the invention by a radiation shielding door having at least two movably arranged radiation-absorbing plates that make up the door and whose end faces represent levers that are joined in the manner, for example, lazy tongs.

In principle, a set of lazy tongs includes a number of individual scissor sections, each formed of two levers connected by a scissor joint. The individual scissor sections are connected to one another by pivots at the ends of the levers. This design permits a linear motion of the scissor joints in one direction. Because of the lever action, this is accompanied by an accordion-like elongation or shortening of the lazy tongs as a whole. At the same time, a rotation of the levers takes place about the scissor joints by a maximum of 90 degrees. If one lever of each scissor section is formed by the end face of a plate, the functionality of a door is obtained. The plates form a compact stack in the contracted end position, and a continuous surface in the other end position.

To achieve a radiation shielding effect, the plates should have a radiation-damping effect. This can be achieved in that the plates are made of, for example, a metallic carrier material and are coated with lead. According to another embodiment, the plates are made of a nonmetallic carrier material to which lead is glued. To reduce weight, the carrier material can be provided with openings. Moreover, it is possible for the plates to be made of a strongly radiation absorbent material, such as Densimed.

In an embodiment, the door travel can be automated. This has the advantage that the door automatically closes itself, for example in the event of a power failure. To this end, a motor-driven actuating unit, in particular electric or pneumatic, can be provided to open and close the door. Naturally, manual operation of the door is also possible.

Moreover, provision can be made that the door can be opened by the actuating unit or manually, and can be closed by gravity, wherein the door can be held in place in the opened position by a magnet and/or a mechanical holding device.

Moreover, the radiation shielding door can be equipped with sensors detecting the size of the object to be inspected. These sensors can, for example, be light curtains. Using this data, the radiation shielding door, which is movable in a continuous manner due to its design, can be opened just far enough so that the object to be inspected can be transported through it unhindered. Precise control of the door can be achieved by installing sensors that detect the degree to which the door is open.

In another embodiment of the present invention, one or more lead flaps can be attached to at least one plate. These flaps are placed such that they cover the joints between two plates when the door is closed, thus achieving still better absorption of radiation. This permits even better sealing of the tunnel opening. The use of a lead flap is particularly useful for the lowest plate in order to ensure shielding even in the region of any transport devices for the object to be inspected. Good radiation protection accompanied by flexibility of the flaps is achieved when rubber/lead flaps are used, for example.

The inventive radiation shielding door offers a number of further advantages over the prior art. For example, a safety mechanism is possible in which the radiation cannot be switched on until after the door is completely closed. Moreover, the inventive radiation shielding door makes reaching into, or indeed entering, the radiation tunnel impossible during operation. By means of multiple radiation shielding doors arranged one behind the other, a lock system can be designed which can improve radiation safety still further. In addition, the inventive radiation shielding doors make it possible to reliably separate the objects to be inspected.

The areas of application of the inventive radiation shielding door are not limited to X-ray inspection systems. Instead, these doors can also be used at entries to buildings or sections of buildings, for example. Possible locations for use include nuclear power plants, research facilities, and the like, for example.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a perspective representation of an opened radiation shielded door,

FIG. 2 illustrates two plates with lead flaps, and

FIG. 3 illustrates a cross-section through an X-ray inspection device with radiation shielded doors.

### DETAILED DESCRIPTION

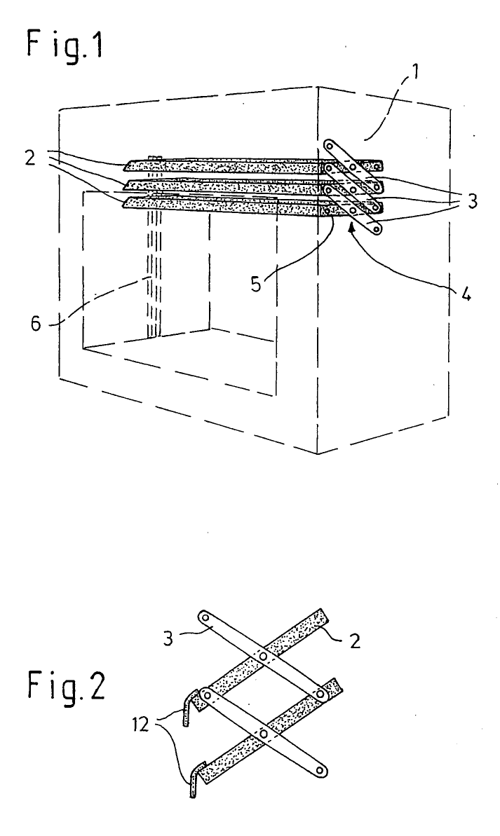

FIG. 1 shows a perspective representation of an inventive radiation shielding door, which in the present example is made up of three individual scissor sections. Each individual scissor section includes an end face of a plate 2 and a lever 3, which are connected to one another by a scissor joint 4. The individual scissor sections are joined together by end joints 5 to form a set of lazy tongs. For reasons of stability, a set of lazy tongs is located at both end faces of the plates 2. A guide rail 6, which can be attached to one or both sides of the radiation shielding door 1, provides additional stability and a guide during opening and closing of the door as needed.

Points in the area of the topmost scissor joint suggest themselves for fastening the door, as they are typically stationary. Movement of the door preferably takes place by means of a motor-driven actuating unit, which in particular can be designed to be electrically or pneumatically driven. The various options for implementing such drives are known to one skilled in the art and thus are not enumerated in detail here. The use of a pneumatic actuating unit is especially advantageous. When this engages at a scissor joint in the upper region of the door, a small motion of the pneumatic cylinder results in a larger travel of the bottom scissor joint, and thus the bottom plate, as a result of the principle of the lazy tongs.

The plates 2 are preferably made of a strongly radiation absorbent material, such as Densimed. This has the advantage that their manufacture requires only a few steps. Alternatively, the plates are made of a metallic carrier material and are coated with lead. According to another alternative, the plates are made of a nonmetallic carrier material to which lead is glued. This has the advantage that a very light carrier material can be used, which to further reduce weight is provided with openings that are covered by the lead layer.

FIG. 2 shows two individual scissor sections of a set of lazy tongs, in which the lower longitudinal sides of the plates 2 are provided with flexible lead flaps 12. When the door is closed, these lead flaps cover the joints between two plates, thus improving the radiation safety of the door as a whole.

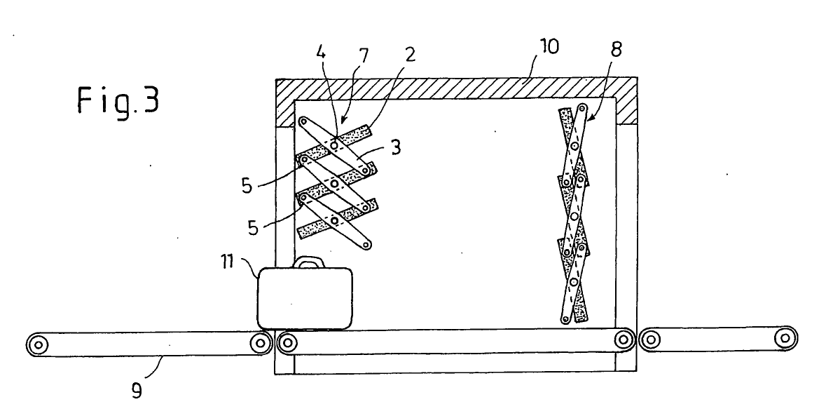

FIG. 3 shows an X-ray inspection device 10 with a radiation shielding door 7 at the entry of the radiation tunnel and a radiation shielding door 8 at its exit. The radiation shielding door 7 is partially open so that the object 11 to be inspected can be brought into the X-ray inspection device 10 by the transport device 9. Once the object 9 has passed the radiation shielding door 7, this door moves to a closed position such as is shown for radiation shielding door 8. Not shown in FIG. 3 for reasons of clarity are the actual inspection unit having a radiation source and detector, and the actuating device for opening and closing the door.

The sensors detecting the position of the door are also not shown in the figures. These sensors are preferably placed in the region of the motor-driven actuator unit. The degree of opening of the door can be determined from the position of the pneumatic cylinder or the position of the electric motor. An optional limit switch is used to check whether the door is fully closed.

Of course, the inventive radiation shielding door is not limited to the design shown in the example embodiment. In particular, the number, shape and arrangement of the plates and the other levers can vary. Likewise, the material of the plates is not limited to those cited in the description.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A radiation shielding door for an X-ray inspection system, comprising:
at least two movably arranged radiation-absorbing plates that form the door, the radiation-absorbing plates having end faces that form levers and that are joined in the manner of lazy tongs.

2. The radiation shielding door according to claim 1, wherein the plates are made of a metallic carrier material and are coated with lead.

3. The radiation shielding door) according to claim 1, wherein the plates are made of a nonmetallic carrier material to which lead is glued.

4. The radiation shielding door according to claim 1, wherein the plates are made of a strongly radiation absorbent material, in particular Densimed.

5. The radiation shielding door according to claim 1, further comprising a motor-driven actuating unit, in particular electric or pneumatic, for opening and closing the door.

6. The radiation shielding door according to claim 1, wherein the door is opened by an actuating unit or manually, and is closed by gravity, and wherein the door is held in place in an opened position by a magnet and/or a mechanical holding device.

7. The radiation shielding door according to claim 1, further comprising sensors that detect a size of an object that is to be inspected.

8. The radiation shielding door according to claim 1, further comprising sensors that detect a position of the door.

9. The radiation shielding door according to claim 1, wherein one or more lead flaps are attached to at least one plate.
